(19) United States
(12) Patent Application Publication
(10) Pub. No.: US 2009/0064103 A1
(43) Pub. Date: Mar. 5, 2009

(54) METHOD FOR EDITING PROGRAMMER LOGIC CONTROLLER (PLC) PROGRAM

(76) Inventor: Hsueh-Fu SHIH, Kuei San Industrial Park (TW)

Correspondence Address: HDLS Patent & Trademark Services, P.O. BOX 220746, CHANTILLY, VA, 20153-0746, US

(21) Appl. No.: 11/849,521

(22) Filed: Sep. 4, 2007

(51) Int. Cl. G06F 9/44; G06F 3/048

(52) U.S. Cl. 717/113; 715/769

(57) ABSTRACT

A method edits a PLC program in a computer with a pointing device such as a mouse. When a drag-and-drop operation is detected, a dragged source is identified. When the dragged source is from libraries, the dragged source is optionally converted into an IEC61131-syntax program portion according to the type of the libraries, namely, function or function block. When the dragged source is a POU (Programming Organization Unit), the dragged source is optionally converted into an IEC61131-syntax program portion according to the source POU type, the currently-edited POU type and criterion of forbidding recursion call. When the drag and drop operation is not feasible, the shape of mouse cursor is changed to remind user. The method of the present invention can advantageously convert items in libraries and POU into IEC61131-syntax program portion to facilitate the PLC programming task.

### BACKGROUND OF THE INVENTION

1. Field of the Invention

The present invention relates to a method editing a PLC program in a computer with a pointing device, especially to a method editing a PLC program in a computer with a pointing device, wherein the dragged source in a drag-and-drop operation is identified and the dragged source is selectively converted to program portion compatible to IEC61131.

2. Description of Prior Art

The software developed for programmer logic controller (PLC) control program is mainly focused on Ladder Diagram (LD). LD language has simple syntax and is extensively used for PLC control program. However, LD language is lack of high-level language properties such as variable data structure, arithmetic calculation, object orientation design, and program control. Moreover, the syntax of LD language also depends on PLC hardware platform. Therefore, International Electrotechnical Commission (IEC) has defined IEC 61131-3 standard language to incorporate high-level language properties into the program developing tool of PLC control program.

IEC 61131-3 defines the following five standard languages.

1. LD

The programming of LD language requires the information of mechanic operation sequence and control loop should be drawn firstly. Afterward, the contact a and the contact b in relay control, the serial and parallel connection and coil are symbolized.

2. Functional Block Diagram, FBD

FBD is composed of predetermined functional block with suitable connection. Therefore, FBD is especially suitable for data flow in control components.

3. Instructional List (IL) or Statement List (SL)

IL is a low level language composed of Boolean algebra and basic logic operation. IL mainly comprises Mnemonics such as AND, OR and NOT.

4. Structure Text (ST)

ST is for PLC with high level language ability such as arithmetic operation, subroutine, loop and condition judgment. Therefore, the PLC with high level language ability can be linked with PC by communication network.

5. Sequential Function Chart (SFC)

SFC decomposes mechanic operation into sequential function flow and then links the sequential functions to realize integral mechanic operation.

IEC 61131-3 program can be input by program entry device for PLC, or by a computer software in a computer linked to the PLC. The former is suitable for inputting command code; while the latter can input all kinds of PLC languages. When using conventional computer compilation languages such as CoDesys or InfoTeam, program drafters need to memorize the syntax of program. When the program includes function call, the program drafters also need to know the arguments in the called function. It is very inconvenient to user.

IEC 61131-3 has specific rule for ST and IL language. It is desirable to provide a drag and drop function to edit the PLC program, whereby user need not to memorize the syntax of the called function.

### SUMMARY OF THE INVENTION

It is the object of the present invention to provide a method editing a PLC program in a computer with a pointing device, whereby an IEC61131-syntax program portion corresponding to a dragged source can be automatically pasted to an edit area by a drag-and-drop operation.

Accordingly, the present invention provides a method editing a PLC program in a computer with a pointing device such as a mouse. When a drag-and-drop operation is detected, a dragged source is identified. When the dragged source is from libraries, the dragged source is optionally converted into an IEC61131-syntax program portion according to the type of the libraries, namely, function or function block. When the dragged source is a POU (Programming Organization Unit), the dragged source is optionally converted into an IEC61131-syntax program portion according to the source POU type, the currently-edited POU type and criterion of forbidding recursion call. When the drag and drop operation is not feasible, the shape of mouse cursor is changed to remind user. The method of the present invention can advantageously convert items in libraries and POU into IEC61131-syntax program portion to facilitate the PLC programming task.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view for demonstrating the PLC program editing method of the present invention.

FIG. 2 shows the flowchart of the PLC program editing method according to the first preferred embodiment of the present invention.

FIG. 3 and FIG. 3A show the flowchart of the PLC program editing method according to the second preferred embodiment of the present invention.

FIG. 4 shows an exemplary operation according to the method of the present invention.

FIG. 5A and FIG. 5B show the results of exemplary operation in FIG. 4.

### DETAILED DESCRIPTION OF THE INVENTION

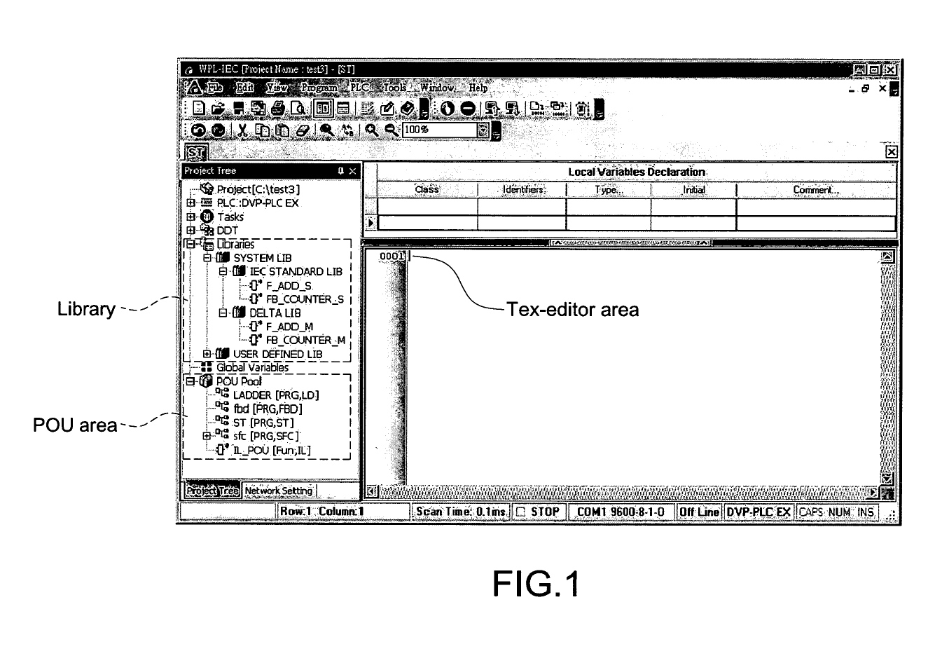

FIG. 1 is a schematic view for demonstrating the PLC program editing method of the present invention, which is implemented in a computer with window operation system. There is a function menu shown at upper portion of the window, a program file manager at lower-right portion and an editor area at lower-right portion. However, the layout is only for demonstration and does not pose limitation to the present invention.

The program file manager has a project tree with two file folders, namely, Library folder and Programming Organization Unit (POU) folder. The files in the Library folder have two types; function (FC) and function block (FB). The POU in project has three types: 1. Program (PG) 2. Function (FC) and 3. Function block (FB). The function in library and POU can be called by user. However, function has been packed and cannot be further edited. A currently-edited program is drafted in the editor area with text input by user.

As shown in this figure, the POU type in the currently-edited program (shown in the editor area) in this window is program and the title of the POU is ST. IEC61131 has following calling rules:

1. Program (PG) can call Function (FC) and Function block (FB).

2. Function block (FB) can call Function (FC) and Function block (FB), but cannot call Program (PG).

3. Function (FC) can call Function (FC), but cannot call and Function block (FB).

4. No recursive call is allowed and POU cannot call itself.

Therefore, the priority in above calling is Program (PG) Function block (FB) Function (FC) and No recursive call is allowed.

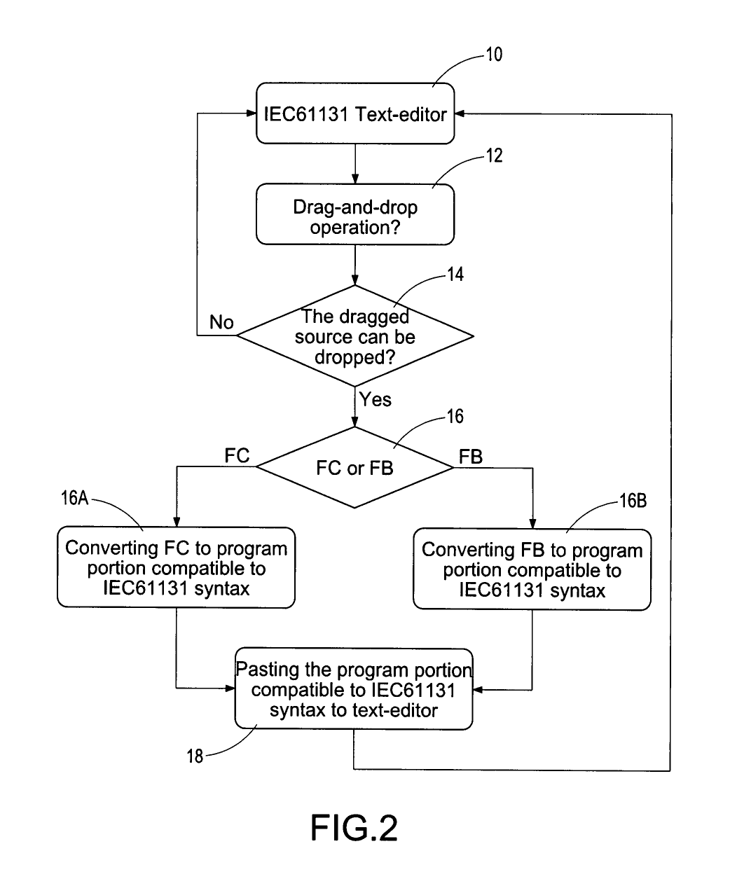

FIG. 2 shows the flowchart of the PLC program editing method according to the first preferred embodiment of the present invention. The PLC program editing method is operated when an IEC61131 text editor works (step 10). When a cursor tool such as a mouse detects a drag and drop operation (step 12), the method of the present invention judges whether a dragged content can be dropped to the text editor (step 14). If false, the process is back to step 10. If true, the dragged content is judged to be FB or FC (step 16). If the dragged content is FC format, then the dragged content is converted to an FC program portion compatible with IEC61131 syntax (step 16A), and the program portion compatible with IEC61131 syntax is then pasted to the IEC61131 text editor (step 18). If the dragged content is FB format, then the dragged content is converted to an FB program portion compatible with IEC61131 syntax (step 16B), and the program portion compatible with IEC61131 syntax is then pasted to the IEC61131 text editor (step 18). Therefore, by the PLC program editing method of the present invention, PLC programmer can directly drag an FC program or an FB program in the library to a text editor. The program text of IEC61131 format corresponding to the FC program or an FB program is pasted to the text editor for facilitating the programmer to edit program.

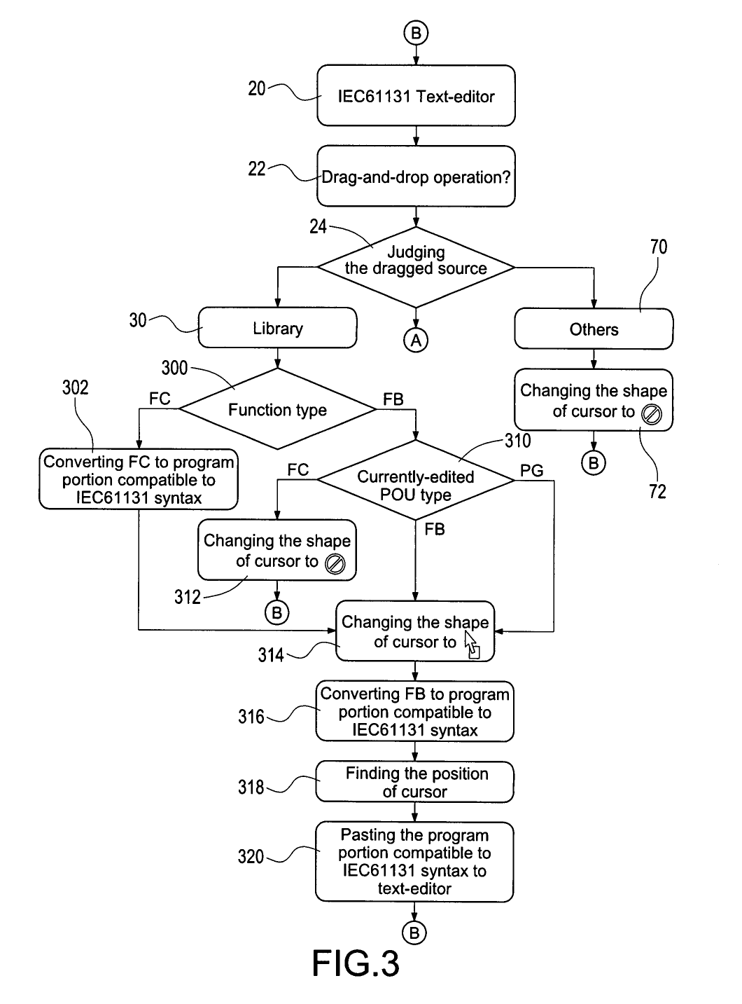

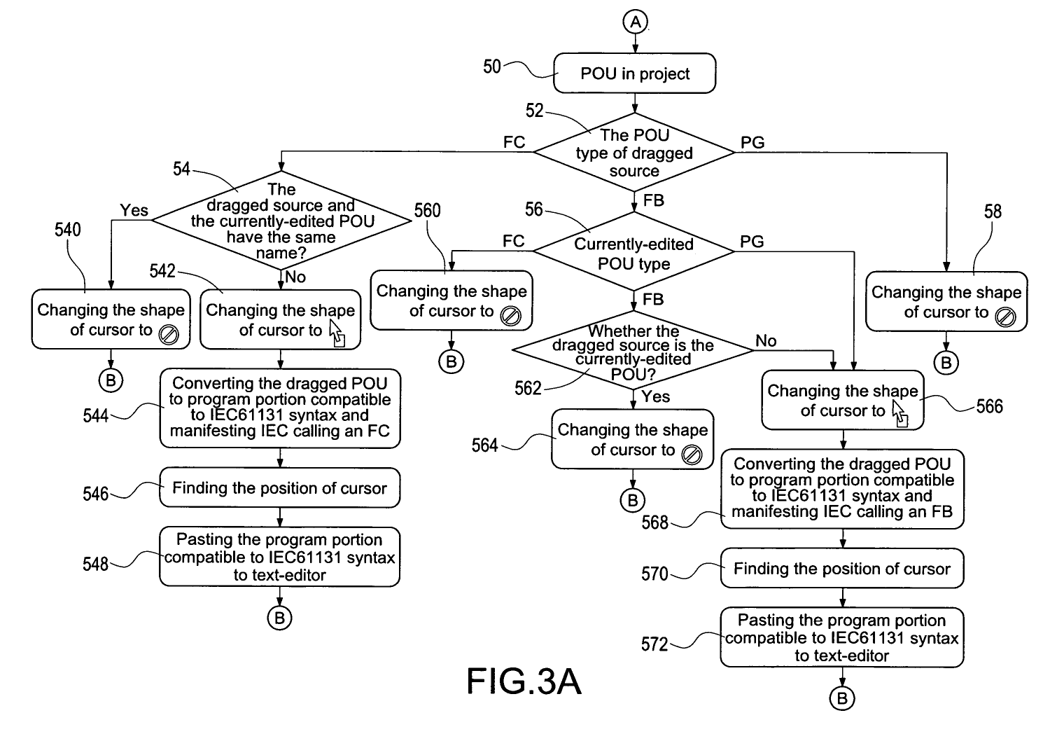

FIG. 3 and FIG. 3A show the flowchart of the PLC program editing method according to the second preferred embodiment of the present invention. The second preferred embodiment demonstrates whether the drop operation is feasible based on the dragged content.

When a pointing tool such as a mouse detects a drag and drop operation in the IEC61131 text-editor area, which allows user input text to edit an currently-edited PLC program (step 20), the method of the present invention judges the source for the dragged content (step 22), the follow-up process is performed when the dragged content is from library (step 30), when the dragged content is from POU in project (step 50), and when the dragged content is from other source (step 70).

When the dragged content is from library (step 30), the function type of the dragged content is judged (step 300). When the function type of the dragged content is FC, then the dragged content is converted to an FC program portion compatible with IEC61131 syntax (step 302), the mouse cursor shape is changed to an icon indicating that “drop” action is allowable (step 314), the position corresponding to the cursor is found (step 318), and then the FC program portion compatible with IEC61131 syntax is pasted to the IEC61131 text-editor area (step 320).

When the function type of the dragged content is FB, then the POU type of the currently-edited program is judged (step 310). When the POU type in currently-edited program is FC, then mouse cursor shape is changed to an icon indicating that “drop” action is not allowable (step 312) because FC cannot call FB. When the POU type in currently-edited program is FB or PG, then mouse cursor shape is changed to an icon indicating that “drop” action is allowable (step 314), the dragged content is converted to an FB program portion compatible with IEC61131 syntax (step 316), the position corresponding to the cursor is found (step 318), and then the FB program portion compatible with IEC61131 syntax is pasted to the IEC61131 text-edit area (step 320).

When the dragged content is from a POU in project (step 50), the POU type for the dragged content is judged (step 52), wherein the POU type for the dragged content is classified into FC (step 54), FB (step 56) and PG (step 58).

When the POU type for the dragged content is FC, the dragged content is judged whether it has the same name as the POU in the currently-edited program (hereinafter, briefed as currently-edited POU) (step 54). If the dragged content has the same name as the POU in the currently-edited program, then the mouse cursor shape is changed to an icon indicating that “drop” action is not allowable (step 540) because recursive call is not allowed. If the dragged content has not the same name as the currently-edited POU, then steps 542 to 548 are perform to indicate that “drop” action is allowable, and to convert the dragged POU to program portion compatible to IEC61131 syntax and manifesting IEC calling an FC, and to find the cursor position and to paste the program portion compatible with IEC61131 to the IEC61131 text-editor area.

When the POU type for the dragged content is FB, the POU type of the currently-edited POU is judged (step 54), and step 560 (the POU type of the currently-edited POU is FC), step 562 (the POU type of the currently-edited POU is FB), and step 566 (the POU type of the currently-edited POU is PG) is performed, respectively.

When the POU type of the currently-edited POU is FC, then the mouse cursor shape is changed to an icon indicating that “drop” action is not allowable (step 560) because FC cannot call FB. When the POU type of the currently-edited POU is FB, then the dragged content is judged whether it has the same name as the currently-edited POU (step 562). If the dragged content has the same name as the currently-edited POU, then the mouse cursor shape is changed to an icon indicating that “drop” action is not allowable (step 564) because recursive call is not allowed. If the dragged content has not the same name as the currently-edited POU, then steps 566 to 572 are perform to indicate that “drop” action is allowable, and to convert the dragged POU to program portion compatible to IEC61131 syntax and manifesting IEC calling an FB, and to find the cursor position and to paste the program portion compatible with IEC61131 to the IEC61131 text-editor area.

When the POU type of the currently-edited POU is PG, then steps 566 to 572 are perform to indicate that “drop” action is allowable and to convert the source POU to program portion compatible with IEC61131 syntax for pasting to the IEC61131 text-edit area.

In step 52, when the POU type of the dragged content is PG, then the mouse cursor shape is changed to an icon indicating that “drop” action is not allowable (step 58) because PG cannot be called.

In step 24, when the POU type of the dragged content is other, then the mouse cursor shape is changed to an icon indicating that “drop” action is not allowable to warn programmer with error operation.

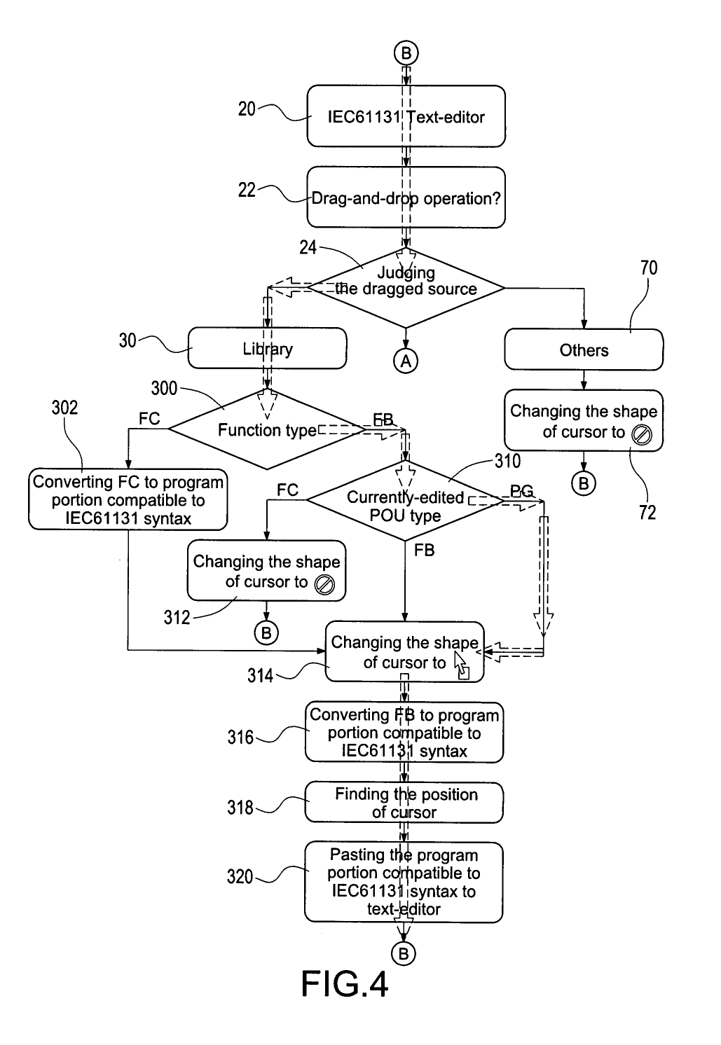

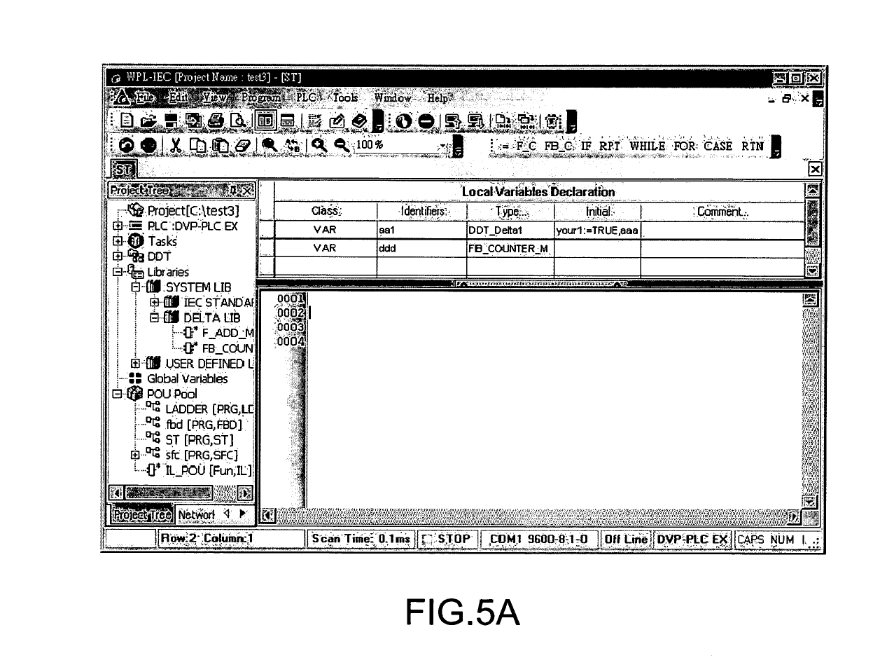

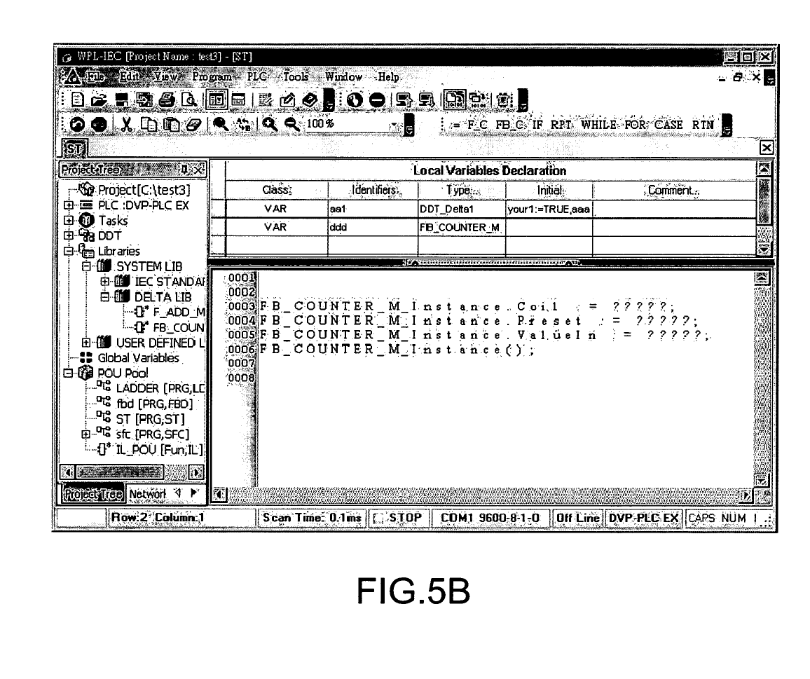

With reference to FIGS. 4, 5A, and 5B, an exemplary operation according to above method is demonstrated, wherein a POU of PG type receives a drag-and-drop operation with FB content in library. The flow of operation is shown by dashed line in FIG. 4.

When the text editor editing a POU of PG type senses a drag-and-drop operation, the text editor knows that the currently-edited POU is PG and the dragged source is FB. Therefore, the process is step 20→step 22→step 24→step 30→step 310→step 314→step 316→step 318→step 320, as shown in FIG. 4. According to the process of the present invention, the dragged source is FB and the currently-edited POU is PG. Therefore, the cursor will change to the shape indicating that “drop” action is allowable. The source POU is converted to a program portion compatible with FB IEC61131 syntax and the program portion compatible with FB IEC61131 syntax is pasted to the IEC61131 text-edit area designated by the cursor.

IEC61131 has very particular syntax for calling function (FC) and function block (FB), which is greatly different to other high-level program. The method of the present invention converts a dragged source to an IEC61131-syntax program portion corresponding to the dragged source when the dragged source is feasible to drop. The IEC61131-syntax program portion contains IEC61131 text program and text arguments to facilitate the programming drafting of programmer.

Moreover, the programmer does not need to memorize the IEC61131 syntax and the programming efficiency can be enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for editing a PLC program in a computer with a pointing device, comprising:
detecting a drag-and-drop operation;
identifying a dragged source; and
converting the dragged source to an IEC61131-syntax program portion corresponding to the dragged source, and pasting the IEC61131-syntax program portion to a text edit area when the dragged source is feasible for a drag-and-drop operation.

2. The method in claim 1, further comprising:
when the dragged source is from a library, then judging a function type for the dragged source.

3. The method in claim 2, further comprising:
when the function type is a function, then converting the function into the IEC61131-syntax program portion corresponding to the dragged source, and pasting the IEC61131-syntax program portion to the text editor area

4. The method in claim 2, further comprising:
when the function type is a function block, then judging a POU type in a currently-edited program.

5. The method in claim 4, further comprising:
when the POU type in the currently-edited program is a function block, then converting the function block into the IEC61131-syntax program portion corresponding to the dragged source, and pasting the IEC61131-syntax program portion to the text editor area.

6. The method in claim 4, further comprising:
when the POU type in the currently-edited program is a program, then converting the program into the IEC61131-syntax program portion corresponding to the dragged source, and pasting the IEC61131-syntax program portion to the text editor area.

7. The method in claim 1, further comprising:
when the dragged source is from a POU in a project, then judging a POU type for the dragged source.

8. The method in claim 4, further comprising:
when the POU type in the dragged source is a function, then judging whether the dragged source has the same name as the POU in currently-edited program;
when the name is different, the function is converted into the IEC61131-syntax program portion and the IEC61131-syntax program portion is pasted to the text editor area.

9. The method in claim 7, further comprising:
when the POU type in the dragged source is a function block, then judging the POU type in currently-edited program.

10. The method in claim 9, further comprising:
changing the shape of cursor to indicate that “drop” action is not allowable, when the POU type is function in currently-edited program.

11. The method in claim 9, further comprising:
when the POU type in currently-edited program is function block, then judging whether the dragged source is the POU in currently-edited program.

12. The method in claim 11, further comprising:
when the dragged source is the POU in currently-edited program, then changing the shape of cursor to indicate that “drop” action is not allowable.

13. The method in claim 11, further comprising:
when the dragged source is not the POU in currently-edited program, then converting the dragged source into the IEC61131-syntax program portion and pasting the IEC61131-syntax program portion to the text editor area.

14. The method in claim 9, further comprising:
when the POU type in currently-edited program is program, then converting the dragged source into the IEC61131-syntax program portion and pasting the IEC61131-syntax program portion to the text editor area.

15. The method in claim 7, further comprising:
when the POU type in the dragged source is a program, then changing the shape of cursor to indicate that “drop” action is not allowable.
